(19) United States
(12) Patent Application Publication
(10) Pub. No.: US 2005/0036626 A1
(43) Pub. Date: Feb. 17, 2005

(54) Method and system for processing a Japanese BTSC signal

(76) Inventor: Hoang Nhu, Irvine, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/641,161

(22) Filed: Aug. 15, 2003

(51) Int. Cl. H04N 7/08; H04H 5/00

(52) U.S. Cl. 381/2; 348/485; 381/16

(57) ABSTRACT

When processing a Japanese BTSC transmission, a main channel and a sub channel are processed separately. Because more components and steps are used to process the sub channel, processing the sub channel takes longer than the main channel. Therefore, a delay is inserted into the main channel. This delay is equal to the sum of the delays resulting from sub channel processing, less the delay pre-inserted into the main channel by a broadcaster. In an embodiment, the delay inserted is 42 samples. The processed main channel and sub channel are used together so as to produce left and right audio signals. All filters are designed to be very flat in the passband with steep rejection in the stop band; filters with the best phase linearity are chosen to allow good phase compensation via simple sample-delay insertion. This results in optimal stereo separation at the L and R decoded outputs.

### BACKGROUND OF THE INVENTION

1. Field of the Invention

The present invention relates to signal processing of a Japanese audio broadcast signal.

2. Related Art

The Japanese Broadcast Television Systems Committee (“JBTSC”) standard audio broadcast signal has three modes of transmission. These modes are mono, stereo, and dual mono. To serve both stereo and mono television sets, the JBTSC standard requires the left (“L”) and right (“R”) channels of a stereo signal to be summed and transmitted as one signal in the space normally occupied by the mono audio signal. The summed L+R output, called the main channel, provides the mono signal of the original audio program content. This summed signal may be received by mono television sets.

To create the stereo signal, the JBTSC system also uses an L−R signal, which is the difference between left and right channels. This signal is referred to as the sub channel, which is FM modulated, or FM carrier channel. While the sub channel alone cannot be used by the television set, it is essential to reconstructing the stereo signal.

A third signal, called the control channel, is inserted into the transmission. The control channel carries information indicating the mode of transmission. Therefore, what is needed is a system for processing the three channels of the JBTSC audio transmission.

### SUMMARY OF THE INVENTION

The main channel and the sub channel in a JBTSC transmission are processed separately by a processing system and method. The sub channel is processed by a sub path. In an embodiment, the sub path includes a bandpass filter centered at approximately 2 f_{H}, so that only the sub channel passes through. The sub channel is then modulated into an in-phase (“I”) signal and a quadrature-phase (“Q”) signal by a set of multipliers. Each of these signals is filtered with a low-pass filter to remove double frequency terms produced by the multipliers. The I and Q signals are combined and demodulated by an FM demodulator and then low-pass filtered. The signal is also processed by a deemphasis circuit, which negates the effect of a preemphasis imposed by a broadcaster.

The main channel is processed by a main path. In an embodiment, the main path includes a low-pass filter identical to the low-pass filter in the sub path. The low-pass filter in the main path rejects all but the main channel. The main channel is also processed by a deemphasis circuit.

In an embodiment, all filters are designed to be very flat in the passband with steep rejection in the stop band; additionally, filters with the best phase linearity are chosen to allow good phase compensation via simple sample-delay insertion. This results in optimal stereo separation at the L and R decoded outputs.

Because more steps and components are involved when processing the sub channel than when processing the main channel, the sub channel takes longer to be processed. Since the main channel and the sub channel are combined to produce the output signals, the phases of each channel must match. Otherwise, the decoder outputs L and R will have poor stereo separation. Therefore, a delay is inserted into the main path of the receiver to compensate for delays resulting from processing in the sub path. In the Japanese BTSC standard, a delay of 20 μs (equivalent to 5 samples at 250 kHz sampling rate) is automatically inserted into the main channel prior to transmission. For this reason, the delay in the main path of the receiver is determined by adding the delays produced by each component in the sub path, and subtracting the 5-sample delay inherent in the main channel. In an embodiment, the delay inserted into the main path of the receiver is equal to 42 samples.

After the delay is inserted, the sum of the results of the sub path and the main path is divided by 2 to produce the left stereo channel of the audio transmission. Similarly, the result of the sub path is subtracted from the result of the main path, the difference being divided by 2, to produce the right stereo channel of the audio transmission.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is an illustration of the relationship between three channels in the JBTSC standard's spectrum.

FIG. 2 is a block diagram of an embodiment of the present invention.

FIG. 3 is a flowchart of a method according to an embodiment of the present invention.

FIG. 4 is flowchart of a sub path method according to an embodiment of the present invention.

FIG. 5 is flowchart of a main path method according to an embodiment of the present invention.

The present invention will be described with reference to the accompanying drawings. The drawing in which an element first appears is typically indicated by the leftmost digit(s) in the corresponding reference number.

### DETAILED DESCRIPTION OF THE INVENTION

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

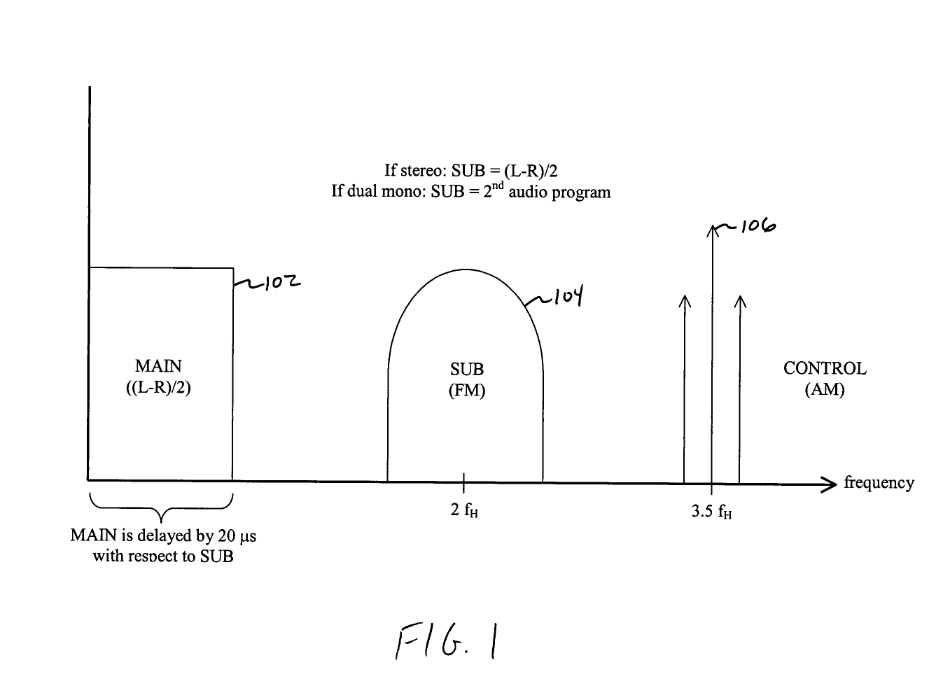

As shown in FIG. 1 a JBTSC audio transmission includes a main channel 102, a sub channel 104, and a control signal 106. Main channel 102 is also referred to as the sum, since it carries the L+R audio signal. Sub channel 104 is FM modulated at 2 f_{H}, f_{H} being the horizontal scanning frequency. This modulating signal is either L−R (if stereo mode) or the second audio program (if dual mono mode). Sub channel 104 is typically centered at 2 f_{H}, f_{H} being the horizontal scanning frequency. If the transmission is in stereo or dual mono mode, control signal 106 includes an AM carrier at 3.5 f_{H}, whose AM sidebands' frequencies indicate whether the transmission is in stereo or dual mono.

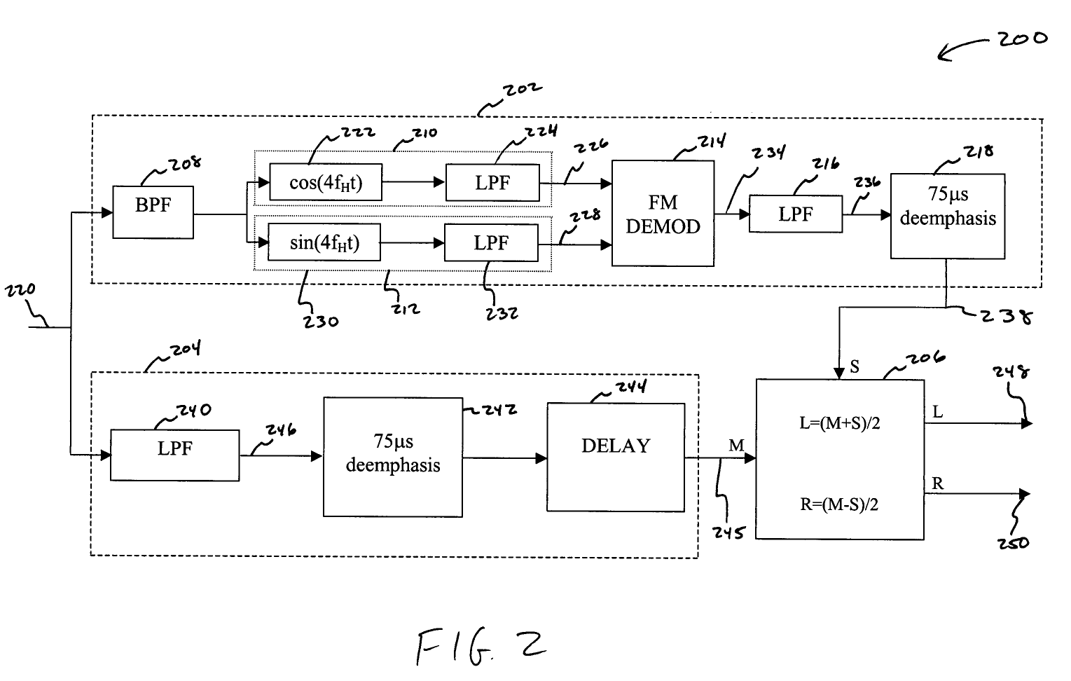

FIG. 2 is a block diagram of a processing system 200 according to an embodiment of the present invention. Processing system 200 includes a sub path 202, a main path 204, and a separator 206. Sub path 202 includes a bandpass filter 208, a first filter path 210, a second filter path 212, an FM demodulator 214, a lowpass filter 216, and a deemphasis circuit 218.

An audio transmission 220, input to processing system 200, is split between sub path 202 and main path 204. In the sub path, bandpass filter 208 filters audio transmission 220. In an embodiment, bandpass filter 208 is a 65^{th}-order FIR filter centered at approximately 2 f_{H} so that only subchannel 104 passes through. Bandpass filter 208 is designed to be flat in the passband with steep rejection in the stop band to reject signals from main channel 102 and control channel 106. In an embodiment, to assist in demodulation, both the in-phase and quadrature-phase (I and Q) version of the signal are applied to FM demodulator 214. In this embodiment, sub channel 104 is split between first filter path 210 and second filter path 212. First filter path 210 produces I signal 226. First filter path 210 includes an in-phase multiplier 222 and an in-phase low-pass filter 224. In an embodiment, in-phase multiplier 222 multiplies channel 104 by cos(4πf_{H}t). In-phase low-pass filter 224 is then used to reject the double frequency term in the signal produced by in-phase multiplier 222. In-phase low-pass filter outputs I signal 226. In an embodiment, filter 224, a 32nd-order FIR filter, is substantially flat in the passband, so as to preserve sidebands in the sub channel. This filter is constrained to have maximum rejection around the 2×image. Above that frequency, constraints can be relaxed due to the fact that there is no input energy there.

Second filter path 212 produces Q signal 228. Second filter path 212 includes a quadrature-phase multiplier 230 and a quadrature-phase low-pass filter 232. In an embodiment, quadrature-phase multiplier 230 multiplies sub channel 104 by sin(4πf_{H}t). Quadrature-phase low-pass filter 230 is then used to reject the double frequency term in the signal produced by quadrature-phase multiplier 230. Quadrature-phase low-pass filter outputs Q signal 228.

I signal 226 and Q signal 228 are both input to FM demodulator 214. FM demodulator 214 applies a difference equation to demodulate the FM signal. In an embodiment, the difference equation is the first-order difference equation:
FMDemod=[Q(n)*I′(n)−I(n)*Q′(n)]/[Q(n)*Q(n)+I(n)*I(n)],
where I′(n)=I(n)−I(n−1). One of skill in the art will recognize that a higher-order difference equation may also be used. FM demodulator 214 outputs demodulated FM signal 234.

Low-pass filter 216 receives demodulated FM signal 234. In an embodiment, low-pass filter 216 filters out everything above, for example, 13 kHz. In an embodiment, low-pass filter 216 is a 10^{th}-order elliptical filter. One of skill in the art will recognize that different filters may be substituted as needed. Low-pass filter 216 outputs signal 236.

Signal 236 is next input to deemphasis circuit 218. In an FM system, the higher frequencies contribute more to the noise than the lower frequencies. Because of this, all FM systems adopt a system of preemphasis where the higher frequencies are increased in amplitude before the transmission is modulated. Thus, when the transmission is received, the higher frequencies must be deemphasized in order to recover the original baseband signal. In an embodiment, deemphasis circuit 218 is set at approximately 75 μs. Deemphasis circuit 218 outputs signal 238. Signal 238 is equal to the difference between the left and right stereo signals, or L−R, and is also referred to as the sub path signal S.

When audio transmission 220 is input to processing system 200, audio transmission 220 is split between sub path 202 and main path 204. Main path 204 includes a low-pass filter 240, a deemphasis circuit 242, and a delay block 244.

Low-pass filter 240 is identical to low-pass filter 216 from sub path 202, and filters out all but main channel 102. The output of low-pass filter 238 is sum signal 246. Deemphasis circuit 242 is identical to deemphasis circuit 218 from sub path 202, and performs the same function.

Delay block 244 inserts a timing delay into sum signal 246. This timing delay is inserted to account for the time required to process and output difference signal 238 in sub path 202. The timing delay is needed because, if the sum and difference signals are out of phase, stereo separation between L and R outputs will be poor.

In the JBTSC standard, a 20 μs delay is automatically inserted into the main channel of the audio transmission by a broadcaster. This is done because a bandpass filter is typically needed to separate the sub channel from the main channel, and the typical delay resulting from such a bandpass filter is approximately 20 μs.

The total delay that needs to be corrected for by delay block 244 is the sum of the delays resulting from components of sub path 202, less the delay pre-inserted into the main channel by the broadcaster. In an embodiment, the components of sub path 202 that add to the total delay are bandpass filter 208 and low-pass filters 224 and 232. Low-pass filter 216 in sub path 202 is identical to low-pass filter 238 in main path 204. Therefore, low-pass filter 216 does not contribute any additional delay. In an example embodiment, bandpass filter 208 is a Remez filter of the 63^{rd} order, resulting in a delay of 32 samples. In the same embodiment, for example, low-pass filters 224 and 232 are Remez filters of the 32^{nd} order, resulting in a delay of 15 samples. In this embodiment, the delay resulting from components of sub path 202 is approximately 47 samples.

In the JBTSC standard, the incoming sample rate is 250 kHz, resulting in each sample equating to approximately 4 μs. Since each sample is approximately equal to 4 μs, the 20 μs delay inserted by the broadcaster equates to approximately 5 samples. Thus, for this embodiment, the total delay inserted into sum signal 246 by delay block 244 is (47−5) samples, or 42 samples. Due to mismatches or imperfections in the initial encoding process, the final delay added may vary slightly from the calculated amount. For example, in the embodiment above, the total delay inserted into main channel 102 may be adjusted to 43 samples. One of skill in the art will recognize that different values for the total delay may be substituted to correspond to the delays produced by different filters used. Delays produced by the filters will depend on the type and order of filters used.

After the delay is inserted, sum signal 245 is output by delay block 244. Sum signal 245 is equal to the sum of left and right stereo signals, or L+R, and may also be referred to as main path signal M.

Sum signal 245 and difference signal 238 are both received by separator 206. Since sum signal 245 is equal to L+R, and difference signal 238 is equal to L−R, the left channel L of the stereo signal may be obtained by adding together sum signal 245 and difference signal 238, and dividing the result in half. Using the notation given above, L=(M+S)/2. Similarly, the right channel R may be obtained by subtracting difference signal 238 from sum signal 245, and dividing the result in half. Using the notation given above, R=(M−S)/2. The left channel L is output through left output 248, and the right channel R is output through right output 250.

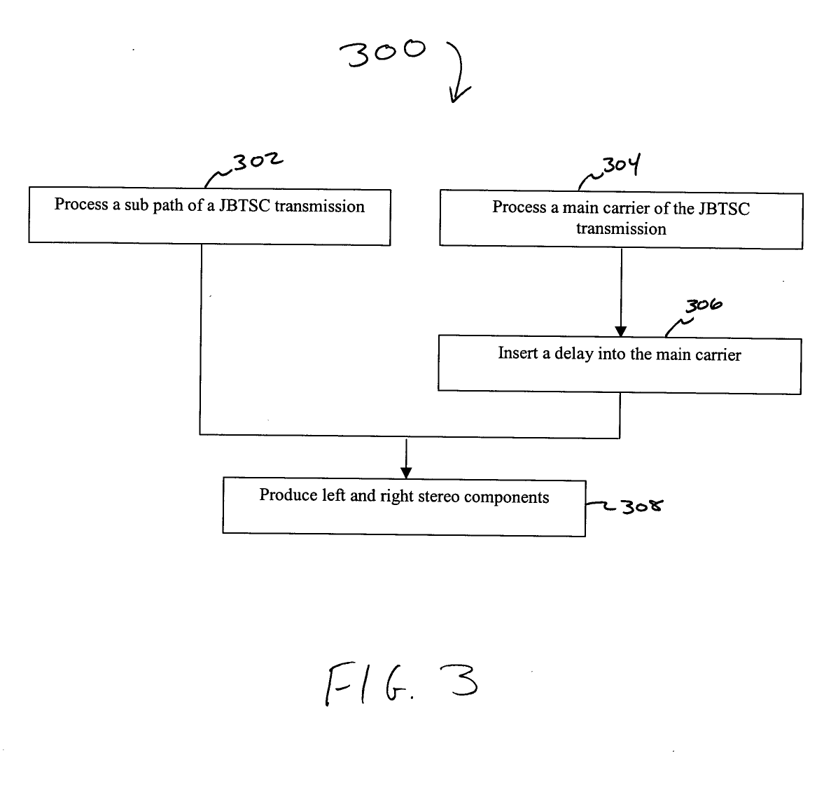

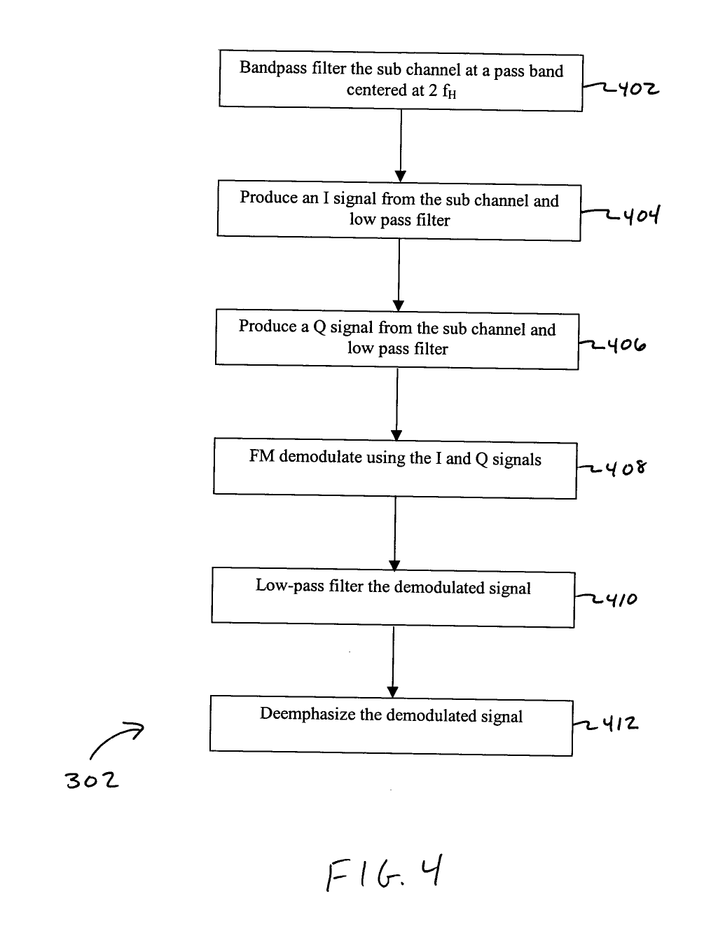

FIG. 3 is a flowchart of a method 300 according to an embodiment of the present invention. In step 302, the sub channel 104 of a JBTSC signal is processed. FIG. 4 is a flowchart that further details step 302. In step 402, transmission 220 is filtered by bandpass filter 208 to separate, for example, sub channel 104. In step 404, an I signal is produced from sub channel 104. Similarly, in step 406, a Q signal is produced from sub channel 104. In step 408, the I and Q signals are demodulated by, for example FM demodulator 214. This produces a demodulated signal, such as, for example, demodulated FM signal 234. In step 410, the demodulated signal is filtered by a low-pass filter. Finally, in step 412, the signal is deemphasized to regain the original baseband signal.

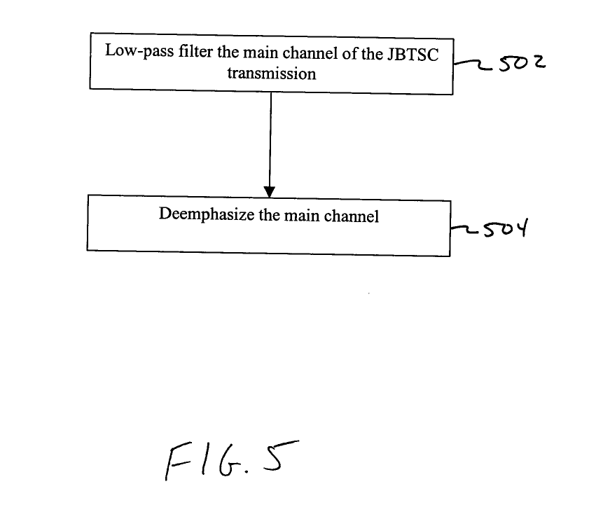

In step 304, the main channel of the JBTSC transmission is processed. In an embodiment, this step is performed concurrently with step 302. FIG. 5 is a flowchart further detailing step 304. In step 502, transmission 220 is filtered to produce the main channel, such as main channel 102. In step 504, the main channel is deemphasized to regain the original baseband signal.

In step 306, a delay is inserted into the main channel. This delay is equal to the delay resulting from step 302 less a delay inherent in the main channel of the transmission. Step 306 may occur separately from step 304. In an alternative embodiment, step 306 occurs at the same time as step 304.

In step 308, left and right stereo components of the transmission are produced from the results of step 302 and step 306.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A system for processing a broadcast audio transmission, comprising:
a main path configured to process a main channel in said transmission;
a sub path configured to process a sub channel in said transmission; and
a separator configured to produce left and right stereo components of said transmission from said main channel and said sub channel;
wherein a delay is inserted into said main path to compensate for delays resulting from said processing in said sub path.

2. The system of claim 1, wherein said delay is equal to a delay resulting from processing in said sub path less a delay inherent in said main channel of said transmission.

3. The system of claim 2, wherein the audio broadcast is a Japanese BTSC signal.

4. The system of claim 3, wherein said delay is approximately equal to 42 samples.

5. The system of claim 2, wherein said sub path comprises:
a bandpass filter centered at approximately 2 f_{H}, wherein f_{H} is a horizontal scanning frequency;
a first filter path configured to produce an in-phase signal;
a second filter path, coupled in parallel to said first filter path, configured to produce a quadrature-phase signal;
an FM demodulator coupled to said first and second filter paths;
a sub-path low-pass filter coupled to said FM demodulator; and
a deemphasis circuit coupled to said sub-path low-pass filter.

6. The system of claim 5, wherein:
said first filter path comprises:
a first multiplier configured to multiply the sub channel by cos(4πf_{H}t); and
a first low-pass filter configured to filter out a double frequency term produced by said first multiplier; and wherein
said second filter path comprises:
a second multiplier configured to multiply the sub channel by sin(4πf_{H}t); and
a second low-pass filter configured to filter out a double frequency term produced by said second multiplier.

7. The system of claim 6, wherein said FM demodulator is configured to demodulate according to a first order difference equation FMDemod=[Q(n)*I′(n)−I(n)*Q′(n)]/[Q(n)*Q(n)+I(n)*I(n)], wherein I is the in-phase portion of the sub channel, Q is the quadrature-phase portion of the sub channel, and I′(n)=I(n)−I(n−1).

8. The system of claim 6, wherein said sub-path filter is configured to pass signals equal to or less than 13 MHz.

9. The system of claim 6, wherein:
said separator produces said left stereo component of said sub channel by adding outputs of the main path and the sub path, and dividing by 2; and
said separator produces said right stereo component of said sub channel by subtracting the output of the sub path from the output of the main path, and dividing by 2.

10. The system of claim 9, wherein said main path comprises:
a main-path low-pass filter configured to pass the main channel;
a deemphasis circuit; and
a delay circuit configured to insert the delay into the main channel.

11. The system of claim 10, wherein said main-path low-pass filter is set to a same frequency as said sub-path low-pass filter.

12. The system of claim 11, wherein each of said filters is designed to be very flat in the passband with steep rejection in the stop band.

13. The system of claim 11, wherein each of said filters has high phase linearity to allow good phase compensation via simple sample-delay insertion.

14. A method of processing a broadcast audio transmission, said method comprising:
(a) processing a sub channel of said transmission;
(b) processing a main channel of said transmission;
(c) inserting a delay into said main channel to compensate for delays resulting from step (a);
(d) producing left and right components of the transmission from the results of steps (a) and (c).

15. The method of claim 14, wherein said delay is equal to the delay resulting from step (a) less a delay inherent in said main channel of said transmission.

16. The method of claim 15, wherein said transmission is a Japanese BTSC transmission.

17. The method of claim 16, wherein said delay is equal to 42 samples.

18. The method of claim 15, wherein step (a) comprises:
(i) filtering said sub channel at a pass band centered at approximately 2 f_{H}, wherein f_{H} is a horizontal scanning frequency;
(ii) producing an in-phase signal from said sub channel;
(iii) producing a quadrature-phase signal from said sub channel;
(iv) demodulating said in-phase signal and said quadrature-phase signal to produce a demodulated signal;
(v) filtering said demodulated signal to filter out signals above a specific frequency; and
(vi) deemphasizing said demodulated signal.

19. The method of claim 18, wherein step (b) comprises:
(i) filtering said main channel to filter out signals above the specific frequency from step (a)(v); and
(ii) deemphasizing said main channel.
